(19) United States
(12) Patent Application Publication
(10) Pub. No.: US 2008/0120497 A1
(43) Pub. Date: May 22, 2008

(54) AUTOMATED CONFIGURATION OF A PROCESSING SYSTEM USING DECOUPLED MEMORY ACCESS AND COMPUTATION

(75) Inventors: Sek M. Chai, Streamwood, IL (US); Nikos Bellas, Chicago, IL (US); Malcolm R. Dwyer, Glendale Heights, IL (US); Daniel A. Linzmeier, Wheeling, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/561,486

(22) Filed: Nov. 20, 2006

(51) Int. Cl. G06F 9/00

(52) U.S. Cl. 713/1

(57) ABSTRACT

A method and system for automatic configuration of processor hardware from an application program that has stream descriptor definitions, descriptive of memory access locations, data access thread definitions having a stream descriptor and a data channel source or sink as parameters, and computation thread definitions having a function pointer, a data channel source and a data channel sink as parameters. The application program is compiled to produce a description of the data flow between the threads as specified in the application program. The hardware is configured to have streaming memory interface devices operable to access a memory in accordance with the stream descriptor definitions, data path devices operable to process data in accordance with the computation thread definitions and data channels operable to connect the data path devices and streaming memory interface devices in accordance with the description of the data flow.

### RELATED APPLICATION

This patent application is related to U.S. patent application Ser. No. 11/131,581 entitled “Method and Apparatus for Controlling Data Transfer in a Processing System”, filed on May 5, 2005, having as first named inventor Sek Chai, and U.S. patent application Ser. No. 11/231,171 entitled “Streaming Data Interface Device and Method for Automatic Generation Thereof”, filed on Sep. 20, 2005, having as first named inventor Sek Chai, both being assigned to Motorola, Incorporated of Schaumburg, Ill.

### FIELD OF THE INVENTION

The present invention relates generally to processing systems and, in particular, to the automatic configuration of processing systems.

### BACKGROUND

Hardware programming is difficult for software engineers who do not have system architecture or hardware expertise. Hardware description languages (HDL) such as VHDL and Verilog are commonplace among hardware engineers, but the designer must set hardware components such as clock and reset signals. Furthermore, although the parallel nature of HDL allows descriptive hardware generation, it is not intuitive for software engineers who have traditionally programmed in C/C++ languages.

In embedded system, high level languages (HLL's) such as C/C++ are traditionally used to program DSPs/microcontrollers rather than reconfigurable hardware such as field programmable gate arrays (FPGA's). New languages such as ‘System-C’ (IEEE Standard no 1666-2005) and ‘SystemVerilog’ (IEEE Standard No 1800-2005), which have a higher level of abstraction than Verilog (IEEE Standard no 1364-1995), are being introduced to the design community, but they are not well received. Other C-based languages include Handel-C™, distributed by Celoxia, Inc., of Austin, Tex., Impulse-C, distributed by Impulse Accelerated Technologies, Inc., of Kirkland, Wash. (Impulse-C is based on Los Alamos National Laboratory's Stream-C), and ASC (‘A Stream Compiler’), distributed by Maxeler, Inc. of New York, N.Y.

It is advantageous to maintain a ‘C/C++’ like language-style for hardware programming, due to the installed software based and training. Some efforts have been made to develop tools that allow programs developed in C/C++ to be converted into hardware (for example by programming the gates of an FPGA). However, the generated hardware is not as efficient because the HLL does not have enough flexibility to describe both the task and data movement. Consequently, the design automation tools generate large and/or slow designs with poor memory performance. For example, these tools are not able to “stream data” to/from memory and/or other hardware accelerators in a computation pipeline.

In devices with decoupled architectures, memory access and computation are performed by separate (decoupled) hardware elements. In one prior approach, a data-flow-graph (DFG) is used to define the computation and a set of stream descriptors are used to define data access patterns. This approach has the ability to generate hardware automatically from the DFG and stream descriptors. However, while the DFGs and stream descriptors are useful in exposing parallelism, they are less likely to be adopted by the software community than an approach based on a C/C++ language.

For general purpose computing, the hardware may be further decoupled by introducing a control processing module in addition to the memory access and computation module.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of exemplary program instructions of a multithreaded application consistent with some embodiment of the invention.

FIG. 2 is a block diagram of a method and apparatus, in accordance with some embodiments of the invention, for configuring hardware of a processing system.

FIG. 3 is an exemplary control flow graph in accordance with certain embodiments of the invention.

FIGS. 4, 5 and 6 are exemplary sections of a symbol table in accordance with certain embodiments of the invention.

FIGS. 7 and 8 are diagrammatic representations of data value allocations in memory.

FIG. 9 is a block diagram of an exemplary system for automatic hardware configuration, consistent with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method and apparatus components related to automated design of processor hardware. Accordingly, the apparatus components and methods have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of automated design of hardware described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates to the configuration of processing hardware from a C/C++ language description of a process. The C/C++ language provides a multi-threaded framework. In the invention, computation and communication are separated (decoupled) explicitly using the ability of the C/C++ language to describe multiple program threads. Computation and memory access are defined in separate threads that facilitate scheduling of the process in the hardware. Data channels are used to communicate among computation threads and data access threads.

In prior approaches computation and memory access are interleaved within the same thread. In such approaches, a compiler has the more difficult task find the parallelism in between computation and data transfers in order to overlap the operations. The memory access patterns are less efficient because they are inferred by the compiler and may not match the intent of the programmer. The compiler applies a series of code transformations to eliminate dependencies, and then generates sequences of load/store instructions based on new access patterns of the transformed loop. This means that data transfer depends on the access pattern inferred by the compiler from the loop structure. The use of stream descriptors in accordance with the present invention enables complex access patterns that are not easily discernible from nested loop structures. Stream descriptors also decouple memory address generation from the actual computation allowing grouped data elements to better match the underlying memory hierarchy.

In one embodiment of the invention, processing hardware is configured automatically for an application defined by a plurality of programming instructions of a high level language that include at least one stream description, descriptive of data access locations, at least one data access thread definition, and at least one computation thread definition. The automatic configuration is achieved by compiling the plurality of programming instructions of the application to produce a description of a data flow between the at least one data access thread and the at least one computational thread, configuring at least one stream access device operable to access data in accordance with the at least one stream description, configuring, in the processing hardware, at least one data path device operable to process data in accordance with the at least one computation thread definition, and configuring, in the processing hardware, one or more data channels operable to connect the at least one data path device and the at least one stream access device in accordance with the description of the data flow.

In a further embodiment of the invention, a system for automatic configuration of processing hardware includes an application program interface (API) tool that includes a data access thread class, a computation thread class and a stream descriptor data type. The API tool is operable to enable a programmer to produce an application program that defines data access threads, computation threads, stream descriptors and data movement between the threads. The system also includes a compiler that is operable to compile the application program to produce a description of data flow referencing the data access threads, the computation threads and stream descriptors of the application program, a means for generating a hardware description and executable code dependent upon the description of the data flow, and a means for configuring the processing hardware in accordance with the hardware description.

To configure the processing system, a programmer generates a set of programming instructions of a high level language to define the application. The set of programming instructions include at least one data access thread definition dependent upon a software class template for a data access thread (each data access thread having a stream descriptor as a parameter, and, optionally, one of a data channel source and a data channel sink as a parameter), at least one computation thread definitions dependent upon a software class template for a computation thread (each computation thread definition having a function pointer, a data channel source and a data channel sink as parameters); and at least one stream descriptor definitions, descriptive of memory access locations. The set of programming instructions of the application are compiled to produce a description of a data flow between the at least one data access thread and the at least one computational thread, then at least one stream access module operable to access a memory in accordance with the at least one stream descriptor definition is configured in the processing system hardware, along with at least one data path module operable to process data in accordance with the at least one computation thread definition and one or more data channels operable to connect the at least one data path module and the at least one streaming memory interface module accordance with the description of the data flow.

In one embodiment, the processing hardware is a hardware accelerator that performs specific computations more efficiently than a general purpose main processor to which it is connected. The hardware accelerator includes a streaming memory interface and a streaming data path. The streaming data interface is used to prefetch, stage and align stream data elements, based upon a set of stream descriptors. For example, the stream descriptors may be starting address, stride, skip, span, type and count values that define the location of data values in a memory. The stream data path performs computations (adds, multiples etc.) defined in the computation threads. In this example, the streaming memory interface, which controls memory access, is decoupled from the stream data path, which performs computations.

In another embodiment, a processor or DMA (direct memory access) engine can be used instead of the steaming memory interface to access the memory. More generally, one or more stream access devices are used to access the data to be processed. A stream access device may be configured in the configurable hardware or implemented on an external device, such as DMA engine or host processor.

Stream descriptors decouple memory address generation from the actual computation by relying on the programmer's knowledge of the algorithm. The programmer uses stream descriptors to express the shape and location of data in memory. The stream access devices use these stream descriptors to fetch data from memory and present the aligned data in the order required by the computing platform. This decoupling allows the stream access device to take advantage of available memory bandwidth to prefetch data before it is needed. The system becomes dependent on average bandwidth of the memory subsystem with less sensitivity to the peak latency to access a particular data element. In addition, it benefits from having fewer stalls due to slow memory accesses, alleviating memory wall issues.

Threads offer a natural, well understood, programming framework to describe concurrently executing components. Threads can represent, for example, a function/loop or a cluster of functions/loops.

The hardware may be a reconfigurable vector processor, a field programmable gate array (FPGA) or an application specific integrated circuit (ASIC), for example.

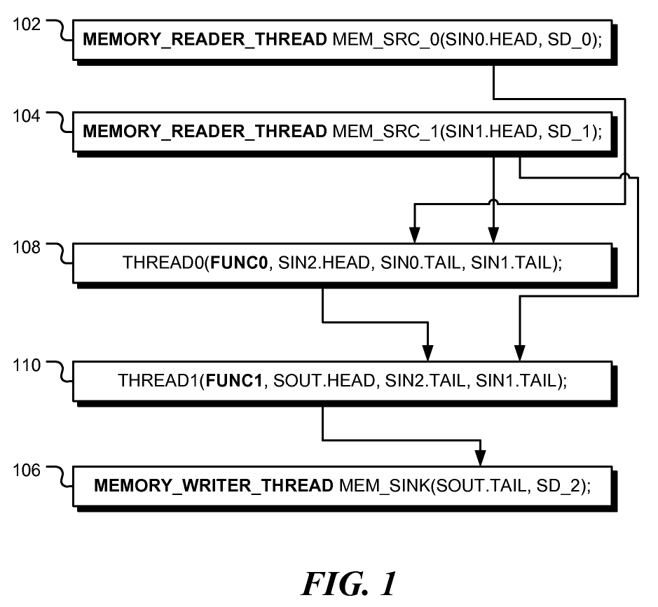

FIG. 1 is a diagrammatic representation of exemplary program of instructions of a multithreaded application consistent with some embodiment of the invention. The instructions are generated by a programmer and may be stored on a computer readable medium. Referring to FIG. 1, the instructions include data access thread definitions 102, 104 and 106 and computation thread definitions 108 and 110. Each data access thread (also referred to as a memory access thread) is created with references to the data channel and stream descriptors. Data access thread definition 102 is a memory reader thread that defines the thread MEM_SRC_0 for reading data from memory. The thread refers to stream input 0 (SIN_0) and stream descriptor 0 (SD_0). Similarly, data access thread definition 104 is also a memory reader thread that defines the thread MEM_SRC_1 for reading data from memory. The thread refers to stream input 1 (SIN_1) and stream descriptor 1 (SD_1). Data access thread definition 106 is a memory writer thread that defines the thread MEM_SIMK for writing data to memory. The thread refers to stream output SOUT and stream descriptor SD_2. A compiler is used to schedule the corresponding data movement (push/pull) onto the data channels. When the threaded program is not used to generate hardware, the compiler generates code to move the data based on memory reader/writer, whereas in hardware the streaming memory interface (SMIF) moves the data. The threads may be accelerated in hardware or as software on scalar programmed processor. The scalar software allows a sequential model of the threaded model to be executed on a scalar processor. This allows operation of hardware accelerated threads to be evaluated and debugged. In addition, the compiler or user can select different threads to accelerate.

The data access and computation threads may be derived from software template classes, such as C++ template classes. In one embodiment, C++ template classes can be used target either software or hardware acceleration using the same software tool or API.

Each computation thread is created by binding a set of parameters, including the pointer references to the function that describes the operation as well as the data channels. Computation thread definition 108 defines a thread that computes the function associated with function pointer FUNC0. The function take its input from the tails (ends) of input stream 0 (SIN0.TAIL) and input stream 1 (SIN1.TAIL) and provides its output to the head of input stream 2 (SIN2.HEAD). A ‘head’ port is an input to a stream: it connects to the output of thread and consumes data (it is a data sink). A ‘tail’ port represents the output of a stream: it connects to the input of a thread and provides data to that thread (it is a data source). The stream and port classes may be provided as C++ template classes. Computation thread definition 110 defines a thread that computes the function associated with function pointer FUNC1. The function take its input from the tails (ends) of input stream 2 (SIN2.TAIL) and input stream 1 (SIN1.TAIL) and provides its output to the head of the output stream 2 (SOUT.HEAD). A fragment of a simple example function is:

```
void FUNC0(stream out, stream in1, stream in2){
    a = in1->get( );
    b = in2->get( );
    value = a * b;
    out->put(value);
}
```

This function reads (gets) data values from the input streams in1 and in2, stores them in variables a and b, multiplies the variables, and then outputs the product value to the output stream. On its own, this function does not define how the input and output values are to be stored in memory, or how computation of the function is to be scheduled in parallel with other functions. The use of threads for both memory access and computation, as shown in FIG. 1, allows memory access and data dependencies to be specified by the programmer. The ‘get’ and ‘put’ functions or methods may be provided as part of an application programming interface (API) and allow movement of data into or out of a data channel. In addition, the API may provide thread classes for computation and data access threads.

Data channels may be, for example, bus connections, tile buffers (for storing data arrays, etc.) or first in, first out (FIFO) buffers for storing sequential data streams.

In FIG. 1, the arrows show the data flow between the different threads. This data flow may be determined by a compiler and is in direct correspondence to data flow between modules in the resulting hardware.

In assigning the parameters to the threads via the thread definitions, the programmer explicitly defines the data flow, data synchronization and methods to be used. In defining the threads, the programmer partitions tasks for parallel operation. As a result, the compiler can be less complex as compared to a compiler for a sequential program (which is required to partition and parallelize tasks). The programmer explicitly defines the synchronization points and methods, whereas a sequential program requires a smart compiler to infer them.

Two new thread classes: computation threads that define the set of operations and data access threads that define the set of data channels between computation threads. These threads can be mapped automatically onto hardware, so that each thread is mapped to a corresponding hardware module. In an example embodiment, only the data access threads are defined when the programmer's objective is to move data from one memory location to another without computing on the data objects (e.g. a memory copy operation).

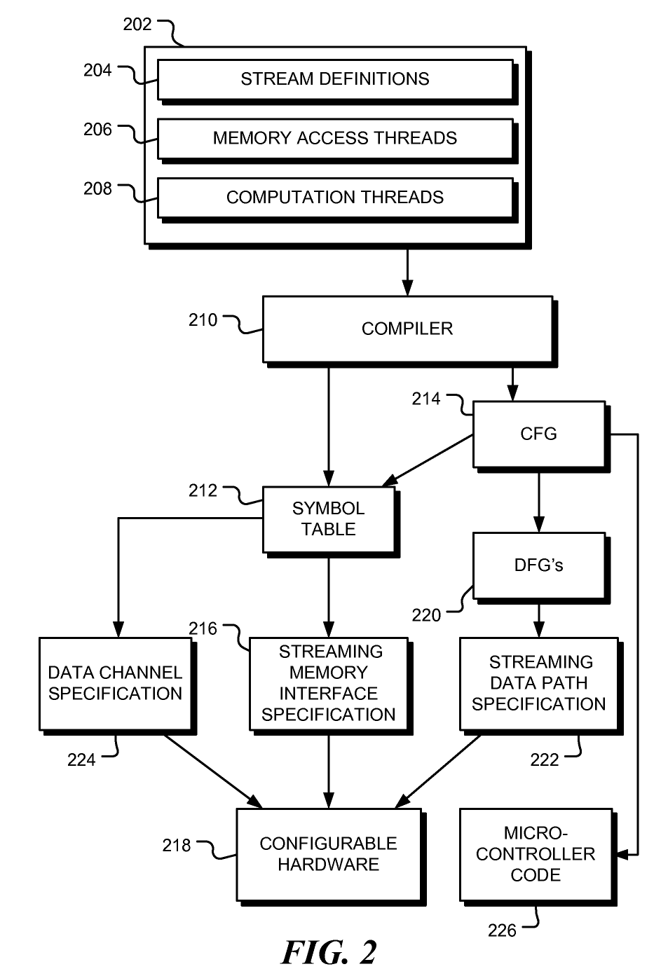

FIG. 2 is a block diagram of a method and apparatus for configuring hardware of a processing system. Referring to FIG. 2, a multi-threaded application 202 includes stream definitions 204, memory access thread definitions 206 and computation thread definitions 208. The multithreaded application may be compiled by a front-end compiler 210 to generate a symbol table 212 and a control flow graph (CFG) 214. Front end compilers are well known to those of ordinary skill in the art. A generic front end compiler may be used. The CFG 214 identifies the dependencies between the different threads of the application (both memory access threads and computation threads).

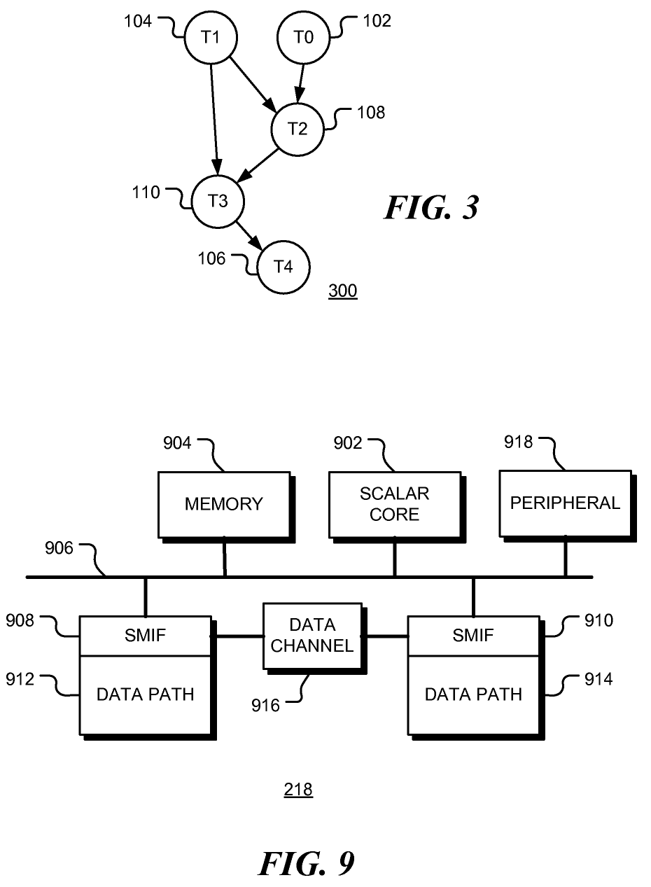

An exemplary control flow graph (CFG) 300, corresponding to the thread definitions in FIG. 1 is shown in FIG. 3. In the example shown in FIG. 3, thread T2 (108) is a child of threads T0 and T1 (102 and 104), and is thus dependent upon T0 and T1. Similarly, thread T3 (110) is a child of both threads T1 (104) and T2 (108).

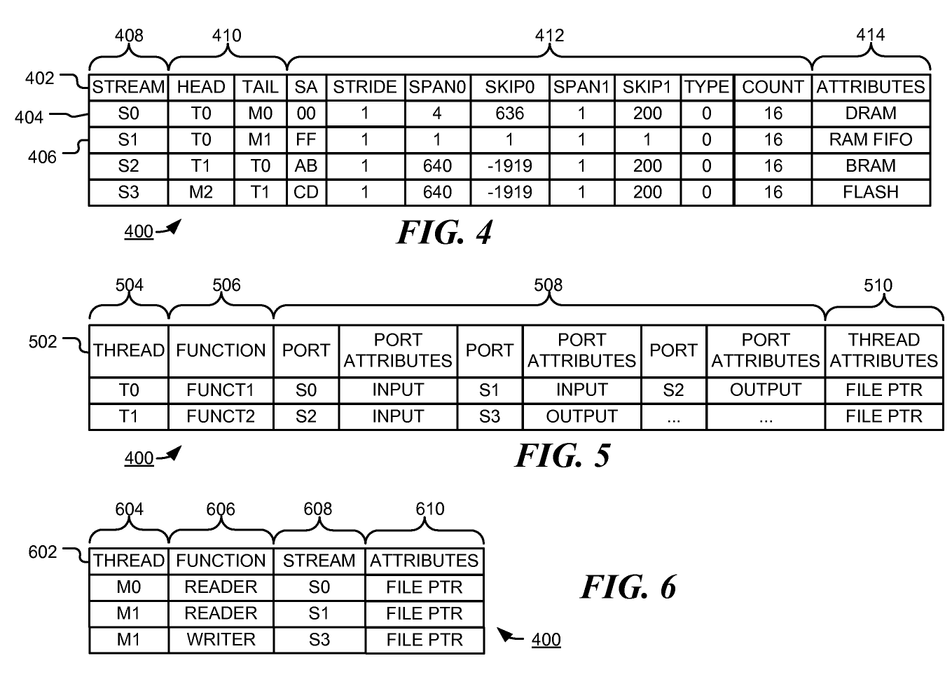

An exemplary section of a symbol table is shown in FIG. 4. The symbol table 400 contains a set of parameters, with labels as defined in header row 402. The symbol table lists symbols declared in the program and the parameters associated with them, such as memory locations. In accordance with one embodiment of the invention, the symbols include streams, defined by a program instruction such as:
stream S0(starting_address, skip, stride, span, type, count);

This instruction defines how data values for stream S0 are to be retrieved from memory. The parameters, starting_address, skip, stride, span, type, count, etc., are stream descriptors that are used by a stream memory interface device to calculate the addresses in memory of successive data values. In some embodiments, a stream descriptor may be represented with a single parameter such as type, or alternatively with a single parameter such as starting address. In yet another embodiment, the parameters such as stride, span, and skip are constants to represent a static shape in memory. The stream parameters are stored in a row of the symbol table for stream s1. In this example, the parameter values for stream S0 are given in row 404 of the table and the parameter values for stream S1 are given in row 406. The symbol table defines how data is routed between threads referenced in the CFG 214 and how the data is stored in the memory of the processor. In particular, for each stream 408 in the symbol table, the symbol table includes references 410 to the head and tail connection of each data channel in the computation threads and data access threads referenced in the CFG. It is noted that the terms ‘head’, ‘tail’, ‘sink’, ‘source’ and ‘ports’ are used to indicate connectivity and direction of data transfer for each data channel. In one embodiment, a compiler automatically determines the direction of data transfer from the CFG without explicitly definition by the programmer. These connections determine if a stream is an input or an output stream. In addition, the stream descriptors 412 are stored in the table. The symbol table 400 may include the attributes 414 of the memory. It will be apparent to those of ordinary skill in the art that various parameters may be used to describe the memory locations and access patterns of the data for input and/or output associated with memory access threads.

A further exemplary section of a symbol table is shown in FIG. 5. The symbol table 400 again contains a set of parameters, with labels as defined in header row 502. This section of the symbol table lists computation threads declared in the program and the parameters associated with them, such functions, input, output and other attributes.

The thread column 504 lists the thread identifier, the function column 506 list a pointer to a function that defines the computation, and the port descriptors 508 list the input and output streams.

Each computation thread is defined by a program instruction such as
THREAD0(FUNCT1, S2.head, S0.tail, S1.tail);

where FUNCT1 is a function pointer and S0, S1 S2 are references to data streams. Threads attributes, such as file pointers in column 510 may be included to allow for debugging, for example.

A still further exemplary section of a symbol table is shown in FIG. 6. The symbol table 400 again contains a set of parameters, with labels as defined in header row 602. This section of the symbol table lists memory access threads 604 declared in the program and the parameters associated with them, such access type 606, stream descriptor 608, and other attributes 610. Each memory access thread is defined by a program instruction such as
MEMORY_READER_THREAD M0(S1.head, SD0);

where S1.head is stream head and SD0 is a stream descriptor.

The CFG and symbol table provide a description of data flow between the different threads. This description is generated by a compiler and may take other forms.

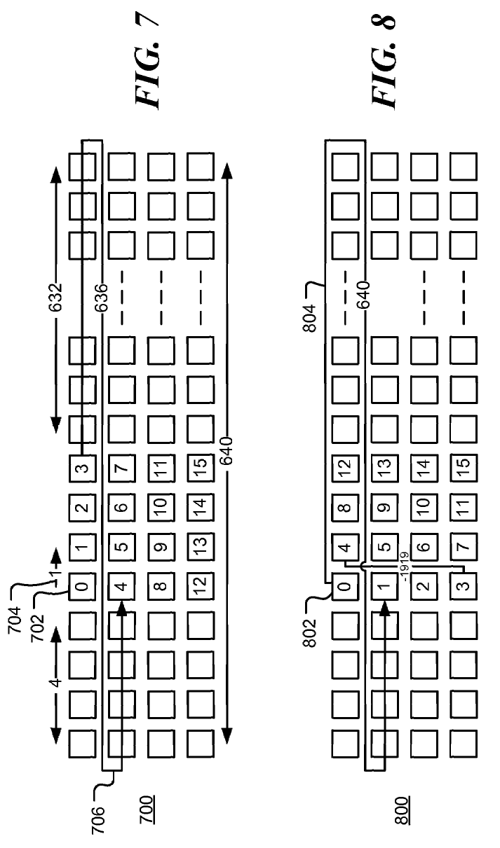

FIGS. 7 and 8 show examples of data access dependent upon the stream descriptors. In FIG. 7, a memory 700 includes 16 locations (number 0-15 in the figure) to be accessed in the order indicated. The starting_address value is the address of the first memory location 702 to be accessed. This address is incremented by the stride value following each access. Once ‘span’ locations have been accessed, the address is increment by the skip value. The type value determines the size (in bits or bytes for example) of each memory location and the count values is the total number of memory locations to the accessed. Multiple skip and span values may be used for more complicated memory access patterns. In FIG. 7, the stride (704) is 1. The span is 4, so the four locations 0, 1, 2, and 3 are accessed before the skip is applied. The skip value (706) is 636, which moves the memory address to the address of memory location 4, since there are 640 locations in each row of this exemplary memory array.

In FIG. 8, the same area or tile of memory is accessed, but the elements are accessed in a different order. In the example, the stride (804) is 640. The span is 4, So the four locations 0, 1, 2, and 3 are accessed before the skip is applied. The skip value is −1919, which moves the memory address to the address of memory location 4, since there are 640, locations in each row of this exemplary memory array (move back 3 rows then move forward 1 [symbol] skip=−3×640+1=−1919). The data in FIGS. 7 and 8 may share a common tile buffer. However, a common FIFO buffer cannot be used since the access orders are different.

In one embodiment, a compiler or tool for hardware configuration uses data flow graphs (DFG's) and stream descriptors as intermediate forms.

Referring again to FIG. 2, the symbol table 212 is used to aggregate references to the stream descriptors. The stream descriptors are used to generate a streaming memory interface specification 216. The specification 216 specifies how the streaming memory interface devices are to be implemented in the configurable hardware 218 and may be used to configure the hardware. The hardware may be configurable only once, during manufacture, or may be re-configurable. An example of reconfigurable hardware is a field programmable gate array. The specifications 216, 222 and 224 may be expressed using register transfer level (RTL) description of a digital processor. This description may be stored in a computer readable medium, such as a computer memory or computer disc.

In addition, microcontroller code 226 may be generated for a scalar processing core. This enables elements of the CFG that are not performed by the data path elements to be performed by a scalar core, such as a general purpose microcontroller core. The microcontroller code may be expressed in an executable and linkable format, for example, and stored in a computer readable medium.

In one embodiment of the invention, one or more dataflow graphs (DFG's) 220 are generated based on the set of operations in the computational threads in the CFG 214. A data flow graph is a directed graph that does contain any conditional elements, such as branch points. In contrast, the CFG can contain conditional elements. The symbol table 212 is used to aggregate references to each thread name and function pointer. For each function, a DFG 220 is created to describe the set of operations in graph notation. The DFG graph is used to generate a specification 222 of the stream data path for the processor. The specification 222 specifies how stream data path devices are to be implemented in the configurable hardware 218 and may be used to configure the hardware.

The symbol table 212 is also used to generate a data channel specification 224. This specification describes how data channels, such as channels linking processing blocks, are to be implemented in the hardware 218.

FIG. 9 is a block diagram of an exemplary system 218 consistent with some embodiments of the invention. Referring to FIG. 9, a scalar processing core 902 and memory 904 are coupled via a bus 906. The scalar is operable, for example, to perform elements of the CFG, such as branches, that have not been used to generate DFG. The memory is used to store the data to be processed and the results of processing.

Also coupled to bus 906 are stream memory interface devices 908 and 910. The stream memory interface devices are operable to pass data to computation elements in the data path blocks 912 and 914. The configuration of the stream memory interface devices is dependent upon the stream descriptors defined by the programmer. The connections between the stream memory interface devices and the data path blocks is dependent upon the memory access threads defined by the programmer. The configuration of the data path blocks is dependent upon the computation threads defined by the programmer.

The stream memory interface devices also control data flow between different data path blocks through data channel 916.

The system may also include one or more application specific peripherals, 918, connected to the bus 906.

Although only two data path blocks with corresponding stream memory interface devices are shown in FIG. 9, any number of data path blocks may be used, limited only by the available hardware resources (such as the total number of gates in a FPGA or area of an application specific integrated circuit (ASIC)).

Referring again to FIG. 3 and FIG. 9, in one embodiment of the invention, the threads T0-T4 (102-106) are invoked when there are data elements available for processing. The threads T0-T4 (102-106) are synchronized in their operations using the stream descriptors 412. In one embodiment, the count value in stream descriptors 412 describes the total number of data elements transferred between threads and can be used to indicate the completion of the thread operation. In another embodiment, the count value in stream descriptors 412 describes the number of interim data elements transferred between threads and can be used to initiate the operation of the child thread when enough data elements are available for computation by the child thread. Stream memory interface devices (908, 910) generate an interrupt for the scalar core 902 to invoke thread operation. In yet another embodiment, hardware flow control can be managed by the stream memory interface devices (908, 910) in transferring data through the data channel 916. For threads that are executed as software on scalar programmed processor, the ‘get’ and ‘put’ functions or methods provided as part of an application programming interface (API) allows synchronization of threads in a sequential operational model.

In one embodiment, the hardware is configured using a device programmer. In a further embodiment, the device is reconfigurable and is programmed prior to execution of application.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for automatic configuration of processing hardware for an application defined by a plurality of programming instructions of a high level language that include at least one stream description, descriptive of data access locations, at least one data access thread definition, and at least one computation thread definition, the method comprising:
compiling the plurality of programming instructions of the application to produce a description of a data flow between the at least one data access thread and the at least one computational thread;
configuring at least one stream access device operable to access data in accordance with the at least one stream description;
configuring, in the processing hardware, at least one data path device operable to process data in accordance with the at least one computation thread definition; and
configuring, in the processing hardware, one or more data channels operable to connect the at least one data path device and the at least one stream access device in accordance with the description of the data flow.

2. A method in accordance with claim 1, wherein configuring at least one stream access device comprises configuring, in the processing hardware, at least one streaming memory interface device.

3. A method in accordance with claim 1, wherein the data access thread definition has a stream description and one of a data channel source and a data channel sink as parameters, and wherein the computation thread definition has a function pointer, a data channel source and a data channel sink as parameters.

4. A method in accordance with claim 1, wherein compiling the plurality of programming instructions includes:
generating executable code for a scalar processor of the processing hardware; and
outputting the executable code to a computer readable medium.

5. A method in accordance with claim 1, wherein compiling the plurality of programming instructions comprises:
generating a control flow graph (CFG) including references to the at least one data access thread and the at least one computation thread;
generating a symbol table with references to the at least one data access thread, the at least one computation thread and the at least one stream descriptor.

6. A method in accordance with claim 1, wherein configuring a data path device of the at least one data path device comprises:
generating a data flow graph (DFG) for a computation thread referenced in the CFG and symbol table, the computation defined by a function associated with the function pointer parameter of the computation thread;
generating a register transfer level (RTL) description of the DFG;
configuring the data path device in the processing hardware in accordance with the RTL description; and
outputting executable processor code associated with the DFG to a computer readable medium.

7. A method in accordance with claim 1, wherein configuring one or more data channels in the processor hardware comprises:
generating a register transfer level (RTL) description of a data channel in accordance with the description of the data flow; and
configuring the data path device in the processing hardware in accordance with the RTL description.

8. A method in accordance with claim 1, wherein a data channel of the one or more data channels is selected from the group consisting of a bus connection, a tile buffer and a FIFO buffer.

9. A method in accordance with claim 1, wherein the processing hardware comprises a field programmable gate array (FPGA).

10. A method in accordance with claim 1, wherein a stream description of the at least one stream description includes at least one of a starting address, a STRIDE value, a SPAN value, a SKIP value, and a TYPE value.

11. A system for automatic configuration of processing hardware, the system comprising:
an application program interface (API) tool comprising:
a data access thread class;
a computation thread class
a stream descriptor data type;
the API tool operable to enable a programmer to produce an application program that defines data access threads, computation threads, stream descriptors and data movement between the threads;
a compiler operable to compile the application program to produce a description of data flow referencing the data access threads, the computation threads and stream descriptors of the application program;
a hardware description generator operable to generate a hardware description and executable code dependent upon the description of the data flow; and
a configuration element operable to configure the processing hardware in accordance with the hardware description.

12. A system in accordance with claim 11, wherein the stream descriptors include at least one of a starting address, a STRIDE value, a SPAN value, a SKIP value, and a TYPE value.

13. A system in accordance with claim 11, wherein the hardware description comprises:
a description of a streaming memory interface device dependent upon a stream descriptor of the application program;
a description of a data path device dependent upon a computation thread of the application program; and
one or more data channels dependent upon data movement between the threads of the application program.

14. A system in accordance with claim 11, wherein the hardware description comprises a register transfer level (RTL) description stored in a computer readable medium.

15. A system in accordance with claim 11, wherein the configuration element comprises a device programmer.

16. A system in accordance with claim 11, wherein the description of the data flow comprising a control flow graph (CFG) and a symbol table and wherein the hardware description generator is operable to generate a data flow graph (DFG) for a computation thread referenced in the CFG and symbol table, wherein the DFG describes a function associated with the computation thread.

17. A system in accordance with claim 11, wherein the configuration element comprises a memory write thread class and a memory reader thread class.

18. A method for automatic configuration of a processing system for execution of an application, the method comprising:
generating a plurality of programming instructions of a high level language to define the application, the plurality of programming instructions including
at least one data access thread definition dependent upon a software class template for a data access thread, each data access thread having a stream descriptor and one of a data channel source and a data channel sink as parameters;
at least one computation thread definitions dependent upon a software class template for a computation thread; each computation thread definition having a function pointer, a data channel source and a data channel sink as parameters; and
at least one stream descriptor definitions, descriptive of memory access locations,
compiling the plurality of programming instructions of the application to produce a description of a data flow between the at least one data access thread and the at least one computational thread;
configuring at least one stream access module operable to access a memory in accordance with the at least one stream descriptor definition;
configuring, in the processing system, at least one data path module operable to process data in accordance with the at least one computation thread definition; and
configuring, in the processing system, one or more data channels operable to connect the at least one data path module and the at least one streaming memory interface module accordance with the description of the data flow.

19. A method in accordance with claim 18, wherein generating a plurality of programming instructions of a high level language comprises a programmer using a software tool that provides an application programming interface (API) to the programmer.

20. A method in accordance with claim 19, wherein generating a plurality of programming instructions of a high level language further comprises the programmer using software methods for data movement provided by the software tool.

21. A method in accordance with claim 18, wherein the processing system comprises a general purpose programmable processor.

22. A method in accordance with claim 18, wherein the processing system comprises a processor having configurable hardware.

23. A method in accordance with claim 18, wherein the software class template for a data access thread and the software template for a computation thread are C++ class templates.

24. A method in accordance with claim 18, wherein compiling the plurality of programming instructions comprises:
generating a control flow graph (CFG) including references to the at least one data access thread and the at least one computation thread;
generating a symbol table with references to the at least one data access thread, the at least one computation thread and the at least one stream descriptor
